(19) United States
(12) Patent Application Publication
(10) Pub. No.: US 2022/0415118 A1
(43) Pub. Date: Dec. 29, 2022

(54) METHODS OF DETECTING GAME PROP OPERATION EVENT AND DEVICES AND SYSTEMS THEREOF

(71) Applicant: SENSETIME INTERNATIONAL PTE. LTD., Singapore (SG)

(72) Inventors: Fei XIE, Singapore (SG); Xinxin WANG, Singapore (SG)

(21) Appl. No.: 17/363,919

(22) Filed: Jun. 30, 2021

Related U.S. Application Data
(63) Continuation of application No. PCT/IB2021/055744, filed on Jun. 28, 2021.

(30) Foreign Application Priority Data
Jun. 24, 2021 (SG) 10202106956S

(51) Int. Cl. G07F 17/32

(52) U.S. Cl. CPC G07F 17/322; G07F 17/3293

(57) ABSTRACT

The examples of the present disclosure provide a method of detecting a game prop operation event and apparatus, device, system and storage medium thereof. When detecting a game prop operation event in a game area, according to a comparison of information of a game prop in collected video frames of the game area, an operation sequence identifier of the game prop in the video frame may be determined, and then whether there is an abnormal game prop operation event is determined according to a matching result of the determined operation sequence identifier and position information of the game prop identified from the video frame. By the above method, whether the operation for the game prop by the operating member follows a game rule can be determined automatically and any abnormal operation event in a game process can be found in time, thereby ensuring orderly progress of the game.

### CROSS REFERENCE TO RELATED APPLICATIONS

This application is a continuation of PCT International Application No. PCT/IB2021/055744 filed on Jun. 28, 2021, which claims priority to Singapore Patent Application No. 10202106956S filed on Jun. 24, 2021. The entire contents of the above referenced applications are incorporated herein by reference for all purposes.

### TECHNICAL FIELD

The present disclosure relates to the field of monitoring technologies, and in particular to methods of detecting a game prop operation event and apparatuses, devices, systems and storage mediums thereof.

### BACKGROUND

Along with technological development, more and more scenarios have higher intelligentization requirements. Taking a game scenario as an example, in a game process, an operation mode of a game prop needs to follow a game rule. At present, any abnormal operation to a game prop in a game process is mainly supervised and found by users themselves, and therefore there may be a phenomenon that an abnormal operation of the game prop is not found in time or some users intentionally cheat in a game process and the like, resulting in an unfair game result and affecting user experiences and the like. Therefore, it is necessary to provide a smarter method to automatically detect an operation event of a game prop in a game process.

### SUMMARY

The present disclosure provides methods of detecting a game prop operation event and apparatuses, devices, systems and storage medium thereof.

According to a first aspect of the examples of the present disclosure, provided is a method of detecting a game prop operation event, including:

obtaining a first video frame of a game area;

obtaining a target detection result by detecting information of one or more game props in the first video frame;

determining an operation sequence identifier of each of the one or more game props in the first video frame according to a comparison of the target detection result and a historical detection result, wherein the operation sequence identifier is used to indicate an order of operating the game prop by an operating member, and the historical detection result is determined based on information of one or more game props in a second video frame collected before the first video frame;

determining whether there is an abnormal game prop operation event occurring in the game area according to a matching result of the determined operation sequence identifier of the game prop and position information of the game prop, wherein the position information is used to indicate a position of the game prop in the game area.

In some examples, the information of the game prop includes at least one of the position information of the game prop or identification information displayed on an identification face of the game prop.

In some examples, the method further includes: storing the operation sequence identifier of the game prop and the information of the game prop in an associated manner.

In some examples, obtaining the first video frame of the game area includes:

obtaining an original video frame of the game area;

in response to detecting that a coverage ratio of the operating member to the game prop in the original video frame is smaller than a preset threshold and a position of the game prop in the original video frame is consistent with a position of the game prop in N frames previous to the original video frame, determining the original video frame as the first video frame, wherein N is a positive integer.

In some examples, obtaining the first video frame of the game area includes:

in response to that a state of a game in the game area is a game prop operation state, obtaining the first video frame of the game area.

In some examples, the coverage ratio of the operating member to the game prop is determined by:

determining a first detection box corresponding to the game prop in the original video frame;

determining a second detection box corresponding to the operating member in the original video frame; and

determining the coverage ratio of the operating member to the game prop according to a coverage ratio of the second detection box to the first detection box.

In some examples, determining whether there is an abnormal game prop operation event occurring in the game area according to the matching result of the operation sequence identifier of the game prop and the position information of the game prop includes:

in response to determining that the operation sequence identifier of the game prop and the position information of the game prop are matched, determining that there is no abnormal game prop operation event occurring in the game area.

In some examples, the game area includes a first sub-area and a second sub-area in which the one or more game props are placed; in response to determining that that the operation sequence identifier of the game prop and the position information of the game prop are matched, determining that there is no abnormal game prop operation event occurring in the game area includes: determining that there is no abnormal game prop operation event occurring in the game area under condition of detecting that a matching result of the operation sequence identifier and the position information of the game prop satisfies the following: the operation sequence identifier indicates that the game prop is the first game prop or the third game prop operated by the operating member, and the position information indicates that the game prop is located in the first sub-area; or

the operation sequence identifier indicates that the game prop is the second game prop or the fourth game prop operated by the operating member, and the position information indicates that the game prop is located in the second sub-area; or

the operation sequence identifier indicates that the game prop is the fifth or sixth game prop operated by the operating member, and the position information indicates that the game prop is located in a target sub-area, wherein the target sub-area is determined based on identification information displayed on identification faces of the first to fourth game props operated by the operating member, and the target sub-area is the first sub-area or the second sub-area.

In some examples, in response to determining that there is an abnormal game prop operation event occurring in the game area according to the matching result of the operation sequence identifier of the game prop and the position information of the game prop, abnormality prompt information is sent.

In some examples, the method further includes:

in response to detecting that a number of game props in the game area is not matched with a number of game props in the game area at the time of determining a game processing result, sending abnormality prompt information.

In some examples, a game in the game area includes a card game and the game prop includes a card.

According to a second aspect of the examples of the present disclosure, provided is an apparatus for detecting a game prop operation event, including:

an obtaining module, configured to obtain a first video frame of a game area;

a detecting module, configured to obtain a target detection result by detecting information of one or more game props in the first video frame;

an operation sequence identifier determining module, configured to determine an operation sequence identifier of each of the one or more game props in the first video frame according to a comparison of the target detection result and a historical detection result, wherein the operation sequence identifier is used to indicate an order of operating the game prop by an operating member, and the historical detection result is determined based on information of one or more game props in a second video frame collected before the first video frame;

an abnormality determining module, configured to determine whether there is an abnormal game prop operation event occurring in the game area according to a matching result of the operation sequence identifier of the game prop and position information of the game prop, wherein the position information is used to indicate a position of the game prop in the game area.

In some examples, the information of the game prop includes at least one of the position information of the game prop or identification information displayed on an identification face of the game prop.

In some examples, the detection apparatus is further configured to store the operation sequence identifier of the game prop and the information of the game prop in an associated manner.

In some examples, when obtaining the first video frame of the game area, the obtaining module is specifically configured to:

obtain an original video frame of the game area;

in response to detecting that a coverage ratio of the operating member to the game prop in the original video frame is smaller than a preset threshold and a position of the game prop in the original video frame is consistent with a position of the game prop in N frames previous to the original video frame, determine the original video frame as the first video frame, wherein N is a positive integer.

In some examples, when obtaining the first video frame of the game area, the obtaining module is specifically configured to:

in response to that a state of a game in the game area is a game prop operation state, obtain the first video frame of the game area.

In some examples, the coverage ratio of the operating member to the game prop is determined by:

determining a first detection box corresponding to the game prop in the original video frame;

determining a second detection box corresponding to the operating member in the original video frame;

determining the coverage ratio of the operating member to the game prop according to a coverage ratio of the second detection box to the first detection box.

In some examples, when determining whether there is an abnormal game prop operation event occurring in the game area according to the matching result of the operation sequence identifier of the game prop and the position information of the game prop, the abnormality determining module is specifically configured to:

in response to determining that the operation sequence identifier of the game prop and the position information of the game prop are matched, determine that there is no abnormal game prop operation event occurring in the game area.

In some examples, the game area includes a first sub-area and a second sub-area in which the one or more game props are placed; in response to determining that the operation sequence identifier of the game prop and the position information of the game prop are matched, determining that there is no abnormal game prop operation event occurring in the game area includes: determining that there is no abnormal game prop operation event occurring in the game area under condition of detecting that the matching result of the operation sequence identifier and the position information of the game prop satisfies the following:

the operation sequence identifier indicates that the game prop is the first game prop or the third game prop operated by the operating member, and the position information indicates that the game prop is located in the first sub-area; or

the operation sequence identifier indicates that the game prop is the second game prop or the fourth game prop operated by the operating member, and the position information indicates that the game prop is located in the second sub-area; or

the operation sequence identifier indicates that the game prop is the fifth or sixth game prop operated by the operating member, and the position information indicates that the game prop is located in a target sub-area, wherein the target sub-area is determined based on identification information displayed on identification faces of the first to fourth game props operated by the operating member, and the target sub-area is the first sub-area or the second sub-area.

In some examples, in response to determining that there is an abnormal game prop operation event occurring in the game area according to the matching result of the operation sequence identifier of the game prop and the position information of the game prop, the abnormality detecting module is further configured to send abnormality prompt information.

In some examples, the detection apparatus is further configured to:

in response to detecting that a number of game props in the game area is not matched with a number of game props in the game area at the time of determining a game processing result, send abnormality prompt information.

In some examples, the game in the game area includes a card game and the game prop includes a card.

According to a third aspect of the examples of the present disclosure, provided is an electronic device including a processor, a memory and a computer program stored in the memory and executable by the processor, where the computer program is executed by the processor to implement the method according to the above first aspect.

According to a fourth aspect of the examples of the present disclosure, provided is a computer readable storage medium storing computer readable instructions thereon, where the instructions are executed by a computer to implement the method according to the above first aspect.

According to a fifth aspect of the examples of the present disclosure, provided is a detection system, including an image collection apparatus, a service system and a user interaction apparatus;

where the image collection apparatus is configured to collect a video of a game area and send the video to the service system;

the service system is configure to: obtain a first video frame from the video; obtain a target detection result by detecting information of one or more game props in the first video frame; determine an operation sequence identifier of each of the one or more game props in the first video frame according to a comparison of the target detection result and a historical detection result, wherein the operation sequence identifier is used to indicate an order of operating the game prop by an operating member, and the historical detection result is determined based on information of one or more game props in a second video frame collected before the first video frame; determine whether there is an abnormal game prop operation event occurring in the game area according to a matching result of the operation sequence identifier of the game prop and position information of the game prop, wherein the position information is used to indicate a position of the game prop in the game area; in response to determining that there is an abnormal game prop operation event, notify the user interaction apparatus;

the user interaction apparatus is configured to send abnormality prompt information to prompt a user.

In the examples of the present disclosure, when detecting a game prop operation event in a game area, according to a comparison result of information of a game prop in collected video frames of the game area, an operation sequence identifier of the game prop in the video frame may be determined, and then whether there is an abnormal game prop operation event is determined according to a matching result of the determined operation sequence identifier and the position information of the game prop identified from the video frame. By the above method, whether the operation for the game prop by the operating member follows a game rule can be determined automatically and any abnormal operation event in a game process can be found in time, thereby ensuring orderly progress of the game.

It should be understood that the above general descriptions and the subsequent detailed descriptions are merely illustrative and explanatory and shall not be intended to limit the present disclosure.

### BRIEF DESCRIPTION OF THE DRAWINGS

The accompanying drawings, which are incorporated in and constitute a part of the present description, illustrate examples consistent with the present disclosure and serve to explain the principles of the present disclosure together with the description.

FIG. 1 is an application scenario diagram according to one or more examples of the present disclosure.

FIG. 2 is a flowchart of a method of detecting a game prop operation event according to one or more examples of the present disclosure.

FIG. 3 is a schematic diagram of determining a coverage ratio of an operating member to a game prop according to one or more examples of the present disclosure.

FIG. 4 is a schematic diagram of a game table of a Baccarat game according to one or more examples of the present disclosure.

FIG. 5 is a schematic diagram of a logic structure of an apparatus for detecting a game prop operation event according to one or more examples of the present disclosure.

FIG. 6 is a schematic diagram of a logic structure of an electronic device according to one or more examples of the present disclosure.

### DETAILED DESCRIPTION OF THE EMBODIMENTS

Embodiments will be described in detail herein, with the illustrations thereof represented in the drawings. When the following descriptions involve the drawings, like numerals in different drawings refer to like or similar elements unless otherwise indicated. The embodiments described in the following embodiments do not represent all embodiments consistent with the present disclosure. Rather, they are merely embodiments of apparatuses and methods consistent with some aspects of the present disclosure as detailed in the appended claims.

The terms used in the present disclosure are for the purpose of describing a particular embodiment only, and not intended to be limiting of the present disclosure. The singular forms such as “a”, ‘said“, and “the” used in the present disclosure and the appended claims are also intended to include multiple, unless the context clearly indicates otherwise. It is also to be understood that the term “and/or” as used herein refers to any or all possible combinations that include one or more associated listed items. Further, the term “at least one” herein represents any one of multiple or any combination of at least two of multiple.

It is to be understood that although different information may be described using the terms such as first, second, third, etc. in the present disclosure, these information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to”.

In order to help those skilled in the art to better understand the technical solutions of the examples of the present disclosure and make the above objects, advantages and features of the examples of the present disclosure clearer and more understandable, the technical solutions of the examples of the present disclosure will be further detailed below in combination with the accompanying drawings.

Along with technological development, more and more scenarios have higher intelligentization requirements. Taking a game scenario as an example, in a game process, operation modes of game props need to follow a game rule. For example, the game props need to be placed by a user in predetermined positions, the game props need to be operated by the user in a predetermined sequence, and the number of the game props needs to follow a preset rule and the like. At present, any abnormal operation in a game process is mainly supervised and found by users themselves, and therefore there may be a phenomenon that a wrong operation for one game prop is not found in time or some users intentionally cheat in a game process causing the abnormal operation not to be found in time and the like, resulting in an unfair game result and affecting user experiences and the like. Take card games as an example, generally, there are card dealing sequence requirements and card dealing position requirements in a game process. In this case, if the detection of any wrong card dealing sequence relies on the users themselves, a problem that detection is omitted or an abnormal operation is not found due to intentional cheat of a user will occur. Therefore, it is necessary to provide a smarter and more accurate detection method to detect an operation event of a game prop in a game process and find an abnormal operation in the game process in time.

Based on the above problems, examples of the present disclosure provide a method of detecting a game prop operation event. A video of a game area may be collected by an image collection apparatus, an operation sequence of a game prop is determined by comparing information of the game prop in video frames collected, and whether a user places the game prop in a predetermined position according to a predetermined sequence in a game process is determined according to whether the operation sequence of the game prop and a placement position of the game prop is matched, and then whether there is abnormal game prop operation event is determined.

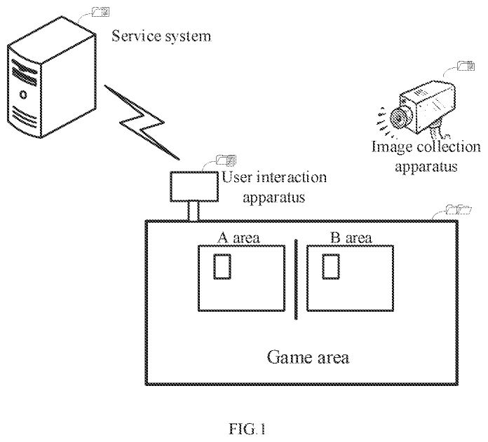

FIG. 1 is an application scenario diagram according to one or more examples of the present disclosure. It should be pointed out that FIG. 1 is only an illustrative example provided for explaining the method of the examples of the present disclosure and the examples of the present disclosure are not limited to the scenario shown in FIG. 1. FIG. 1 shows a scenario of a card game. One or more image collection apparatuses 12 may be disposed near a game area 11 (e.g. a game table) to collect a video of the game area. The image collection apparatus may be any device which is capable of capturing images, such as a camera, an intelligent monitoring device, a computer device connected with a camera, and so on. Then the collected video is sent to a service system 13. The service system 13 may communicate with the image collection apparatus 12 in a wired or wireless manner. The service system 13 may detect the video and determine whether there is an abnormality in a game process based on the detection result. When detecting that there is an abnormality in the game, the service system 13 may send abnormality prompt through a user interaction apparatus 14 in the game area. The game area 11 may include an area “A” and an area “B” where cards dealt by a user are placed. In a game process, the cards should be dealt to the area A and the area B in a predetermined sequence. Therefore, in a game process, the service system 13 needs to determine whether a sequence in which a user deals cards to the area A and the area B complies with a game rule according to the video collected by the image collection apparatus.

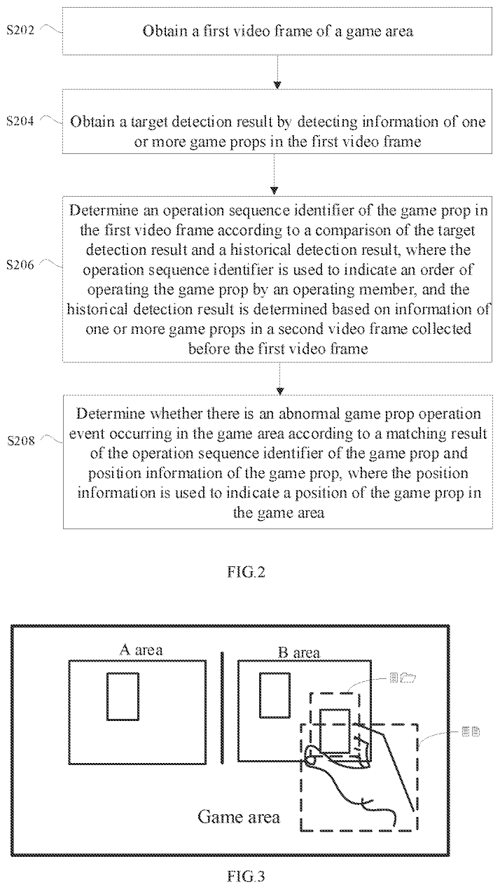

Specifically, as shown in FIG. 2, the method of detecting a game prop operation event in the examples of the present disclosure may include the following steps.

At step S202, a first video frame of a game area is obtained.

At step S204, a target detection result is obtained by detecting information of one or more game props in the first video frame.

At step S206, an operation sequence identifier of the game prop in the first video frame is determined according to a comparison of the target detection result and a historical detection result, wherein the historical detection result is determined based on information of one or more game props in a second video frame, the second video frame is collected before the first video frame, and the operation sequence identifier is used to indicate an order of operating the game prop by an operating member.

At step S208, whether there is an abnormal game prop operation event occurring in the game area is determined according to a matching result of the operation sequence identifier of the game prop and position information of the game prop, where the position information is used to indicate a position of the game prop in the game area.

The method of detecting a game prop operation event in the examples of the present disclosure may be performed by a specified service system. The service system may be a mobile phone, a laptop computer, a server, and a server cluster and the like, which is not limited herein.

The game prop in the examples of the present disclosure may be various props used in a game process, for example, card, chip, coin token and dice and the like. The game prop operation event may be an event in which a user performs various operations for a game prop by hand or by another operating member, which may be defined according to actual application scenario. For example, in some examples, the game in the game area may be a card game, the game prop may be card, and the game prop operation event may be an operation event for cards, such as card dealing, card flopping, card playing and card squinting.

In the step S202, the first video frame of the game area may be obtained, where the first video frame may be one or more video frames in the video of the game area collected by the image collection apparatus.

In the step S204, after the first video frame is obtained, the target detection result may be obtained by detecting the information of the one or more game props in the first video frame. The information of the game prop may be various types of information that can distinguish the game prop from other game props in the first video frame, for example, the information may be position of the game prop, external appearance attribute of the game prop, state information of the game prop, identification information of the game prop and the like. The target detection result may be a detection result obtained by detecting the information of the one or more game props in the first video frame, for example, may be information of each identified game prop.

In the step S206, after the target detection result of the first video frame is obtained, the target detection result may be compared with a historical detection result, where the historical detection result is a detection result obtained by detecting information of one or more game props in a second video frame, and the second video frame may be one or more video frames collected before the first video frame. The operation sequence identifier of the game prop in the first video frame may be determined according to a comparison of the target detection result and the historical detection result. The operation sequence identifier may be used to indicate an order of operating the game prop by an operating member. The operation sequence identifier may be various types of identification information configured to distinguish the sequential orders of operating each game prop by the operating member, for example, may be number, letter and the like. For example, the operation sequence identifier of the first game prop operated by the operating member may be denoted by 1 and the operation sequence identifier of the second game prop may be denoted by 2, and so on. By comparing the information of the game props in the video frames collected by the image collection apparatus, a latest game prop in the video and a game prop in the video frame which is most recently operated by the operating member may be determined, so as to determine the operation sequence identifier of the game prop in the video frame. Taking a card game as an example, if two cards are identified in the second video frame, information such as position and identifier of the two cards may be determined respectively. When three cards are identified in the first video frame, the card latest dealt by a user may be determined in consideration of the determined information of the two cards in the second video frame.

The operating member mentioned in the examples of the present disclosure may be hand, or may be another member for clamping or fixing a game prop, for example, a game prop fixing member and the like.

In the step S208, after the operation sequence identifier of the game prop in the first video frame is determined, whether there is an abnormal game prop operation event may be determined according to whether the operation sequence identifier of the game prop and the position information of the game prop are matched. The position information of the game prop may be various types of information for indicating the position of the game prop in the game area. For example, a coordinate system may be established for the game area to indicate the position of the game prop in the game area with position coordinates. Because a view angle of the image collection apparatus usually remains unchanged, the position of the game prop in the game area may be determined according to the position of the game prop in the first video frame. Generally, in a game process, each game prop needs to be sequentially placed in each specified position in the game area, for example, the first game prop operated is placed in an area 1, the second game prop operated is placed in an area 2, and the third game prop operated is placed in an area 3. Therefore, a matching relationship between the operation sequence and the placement area of the game prop may be determined based on a game rule. Then, based on whether the operation sequence identifier of the game prop identified from the video frame and the position information of the game prop are matched, it may be determined whether the game prop is placed in the specified position according to a preset sequence. In this way, whether an abnormal operation event occurs can be determined.

In some examples, every time a game prop is operated, it may be determined whether the operation for the game prop is abnormal, for example, determining whether the game prop is placed in a correct position. In some examples, the operation sequence and the placement position of each game prop may be firstly determined, and then after the operations for all game props are completed, whether there is an abnormal operation is determined according to the operation sequence and the placement position of each game prop. The specific operations may be set according to actual requirements, which is not limited in the examples of the present disclosure.

In some examples, the information of the game prop may be the position information of the game prop, and the position information of the game prop may be various types of information for indicating the position of the game prop in the game area, for example, may be position coordinate. In some scenarios, the game prop may include a face marked with identification information of the game prop (hereinafter, also referred to as identification face). Therefore, the information of the game prop may be the identification information displayed on the identification face of the game prop. For example, taking a game prop as card, the identification information of the game prop may be suit, point and the like on the face of the card.

In some examples, after the operation sequence identifier of the game prop in the first video frame is determined, the operation sequence identifier of the game prop and the information of the game prop may also be stored in an associated manner. Thus, after a subsequent video frame collected after the first video frame is obtained, a game prop newly appearing in the subsequent video frame or a game prop operated latest may be determined according to the pre-stored operation sequence identifier of each game prop, the pre-stored information of each game prop and the information of one or more game props detected in the subsequent video frame. By way of this, the operation sequence identifier of each game prop in a video frame may be determined.

Of course, because the collected video reflects the entire process in which each of the game props is operated by the operating member, in some video frames, the operation for a certain game prop by the operating member may not be completed yet. For example, in some video frames, the game prop is just picked up by the operating member and has not been completely placed in the specified area of the game area. Thus, the information of the game prop determined using such video frames may be inaccurate due to, for example, the identification information of the game prop may be blocked by the operating member, and the current position of the game prop in the video frame is not the final position where the game prop will be placed by the operating member. Therefore, when the first video frame is obtained, it may be obtained as a video frame with a stable detection result of the game prop so as to be used for determining the position information and the identification information and the like of the game prop. For example, in some examples, when the first video frame is obtained, an original video frame of the game area may be firstly obtained, and then the original video frame is determined as the first video frame in response to detecting that a coverage ratio of the operating member to the game prop in the original video frame is smaller than a preset threshold and a position of the game prop in the original video frame is consistent with a position of the game prop in N frames previous to the original video frame, where N is a positive integer. The N frames previous to the original video frame refer to N successive video frames in a video stream or sampled video stream, and an ending frame among the N successive video frames is just a previous frame of the original video frame. By determining that the coverage ratio of the operating member to the game prop in the video frame is smaller than the preset threshold, whether the current game prop is separated from the operating member may be determined, that is, whether the current game prop is being operated by the operating member may be determined. By determining that the position of the game prop is not changed in a plurality of successive video frames, it may be determined that the operation for the game prop by the operating member is completed, and the game prop is in a stable placement state. The determination of the first video frame in combination with the above two types of information may ensure the information of the game prop identified from the determined first video frame to be more accurate.

Of course, a game in the game area usually has a plurality of states, for example, the game may have a game preparation state, a game prop operation state, and a game result processing state and the like. When the game is in a game preparation state, the user may predict a game result, for example, the user may predict a win or lose result of each player in the game and bet with a coin token. When the game is in a game prop operation state, the user may operate a game prop, for example, deal or flop cards. When the game is in a game result processing state, the user may determine a game result based on circumstances of game props in the game area, for example, calculate a score of each player based on circumstances of cards in the game area to determine a win or lose result of the game and the like. Generally, the game prop operation event occurs in the game prop operation state. Therefore, before the video frame is obtained, a current state of the game may be firstly determined according to the video of the game area collected by the image collection apparatus. When the game state in the game area is the game prop operation state, the first video frame of the game area is obtained and the operation of detecting the information of the game prop in the first video frame is performed.

In some examples, when the coverage ratio of the operating member to the game prop is determined, the operating member and the game prop in the video frame may be detected based on a target detection algorithm. As shown in FIG. 3, for example, when the coverage ratio of the operating member to the game prop in the first video frame is determined, a first detection box 31 corresponding to the game prop and a second detection box 32 corresponding to the operating member may be determined in the first video frame, and then the coverage ratio of the operating member to the game prop is determined according to a coverage ratio of the second detection box 32 to the first detection box 31.

In some examples, when whether there is an abnormal game prop operation event occurring in the game area is determined according to a matching result of the operation sequence identifier of the game prop and position information of the game prop, a matching relationship of the operation sequence identifier and the position information may be firstly determined based on a game rule, for example, the position information matched with the first game prop operated is area 1, and the position information matched with the second game prop operated is area 2. Next, whether the operation sequence identifier of the game prop identified from the first video frame and the position information of the game prop identified from the first video frame are matched is determined, for example, whether the game prop with the operation sequence identifier being 1 is in the area 1 is determined. If matched, it is determined that there is no abnormal game prop operation event occurring in the game area and otherwise, it is determined that there is an abnormal game prop operation event occurring in the game area, and at this time, prompt or warning information may be sent.

In some examples, the game area includes a first sub-area and a second sub-area where the game props are placed and the game props should be dealt to the first sub-area and the second sub-area according to a preset sequence. For example, the first or third game prop is placed in the first sub-area, and the second or fourth game prop is placed in the second sub-area, and whether the fifth or sixth game prop is placed or placed in which area is determined based on the identification information of the previous four game props. In this case, when determining whether the operation sequence identifier of the game prop is matched with the position information of the game prop, if the operation sequence identifier identified from the video frame indicates that the game prop is the first or third game prop operated by the operating member and the position information identified from the video frame indicates that the game prop is located in the first sub-area, it is determined that the operation sequence identifier is matched with the position information. Optionally, if the operation sequence identifier identified from the video frame indicates that the game prop is the second or fourth game prop operated by the operating member and the position information identified from the video frame indicates that the game prop is located in the second sub-area, it is determined that the operation sequence identifier is matched with the position information. Optionally, if the operation sequence identifier identified from the video frame indicates that the game prop is the fifth or sixth game prop operated by the operating member and the position information identified from the video frame indicates that the game prop is located in a target sub-area, it is determined that the operation sequence identifier is matched with the position information. The target sub-area is an area selected from the first sub-area and the second sub-area based on the identification information displayed on the identification faces of the previous four game props operated by the operating member.

In some examples, when determining that there is an abnormal game prop operation event occurring in the game area according to the matching result of the operation sequence identifier of the game prop and the position information of the game prop, abnormality prompt information may be sent. For example, when it is determined that the operation sequence identifier of the game prop and the position information of the game prop are not matched, for example, the game props should be placed in the area A and the area B in a preset sequence, for example, the third game prop should be placed in the area B but the video detection shows the third game prop is not placed in the area B, an abnormality prompt may be sent. In some scenarios, a user interaction apparatus may be disposed in or near the game area, the abnormality prompt may be sent out through the user interaction apparatus in a case of any abnormality. The user interaction apparatus may be a terminal, a computer, a server, etc., which is provided with an interaction interface for interaction with a user. In some examples, besides the interaction interface, the user interaction apparatus is further provided with a sound sensor, a speaker and so on. For example, a voice prompt may be output through the user interaction apparatus to prompt the user about an abnormality, or a text or image prompt may be output through an interaction interface on the user interaction apparatus to prompt the user about an abnormality. Of course, the voice prompt and the image prompt may be output at the same time. With the voice or image prompt, the user may find any abnormal operation existing in the game process in time and perform corresponding processing, so as to ensure the game proceeds in order.

In a game process, in order to make the game smarter and improve the user experiences, in addition to determining whether there is an abnormal operation event in a game process based on the video of the game area collected by the image collection apparatus, statistics may be performed for a game result based on state information and identification information of the game prop in the video so as to automatically output a game processing result at the end of the game. Taking a card game as an example, the information such as suit and point and the like of the cards in each video frame may be calculated in real time, and the information such as suit and point and the like of the cards of each player may be determined based on the video frame and then stored. After each round of game is completed, a game result may be determined based on the stored information such as suit, point and the like of each player. In order to ensure the number of current cards in the game area is consistent with the number of cards in the game area at the time of determining a game processing result, when the game result can be determined, a user will no longer continue placing game props into the game area. In some examples, when it is detected that the number of current cards in the game area is not matched with the number of cards in the game area at the time of determining a game processing result, abnormality prompt information is sent to help the user to find the abnormality in time and perform processing.

In order to further explain the method of detecting a game prop operation event in the examples of the present disclosure, the explanation will be made below in combination with a specific embodiment.

Computer vision technology has already been widely applied to various kinds of table games. Images of a game area are collected by a camera and then an on-going game is monitored and analyzed based on the images so as to automatically identify any non-compliant action on the game table and automatically calculate a payout result of each round of game. In this way, the actions on the game table will be more compliant and the game will be smarter and thus the game result will be fairer and more reliable.

Baccarat game is a common card game. The Baccarat game includes Bank, Play, Tie and Pair. A player may choose to place a bet on any one of Bank, Play, Tie and Pair according to his own idea. After the player bets, a dealer will draw 4-6 cards from 3-8 packs of shuffled cards and a sum of two cards of the player and a sum of two cards of the banker are compared to see which sum is more approximate to 9, or see whether the Banker or the player has a pair or whether their points are equal, and then the payout result of each player can be calculated according to the points of the cards and how much the player bets.

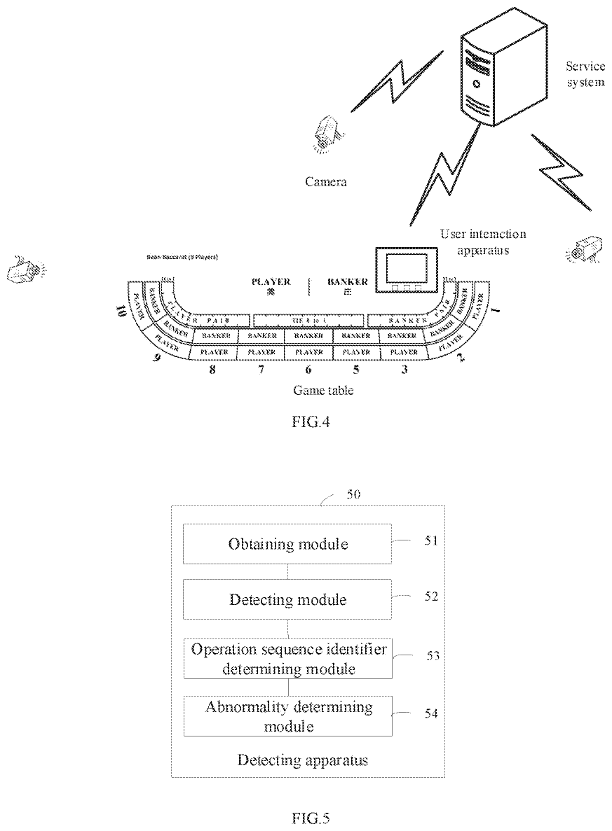

FIG. 4 shows a schematic diagram of a Baccarat game, in which one camera is disposed above and at both sides of a game table respectively to monitor circumstances occurring to the game table. Video data collected by the cameras will be sent to a service system. The service system may analyze a current state of the game based on the images, and perform a detection logic in the corresponding state. In the service system, the Baccarat game is divided into five states, i.e. idle, betting, gaming, payout, and halt. In different states of the game, the service system will invoke different detection logics to detect the game. After a user switches a game from the idle state to the betting state through a user interaction apparatus on the game table (trigger the game to start), the service system will determine a current state of the game based on the video frames collected by the cameras, and automatically completes state switching and performs a corresponding detection logic in the state. A user interaction apparatus is also disposed near the game table, so that a user may interact with the service system through the user interaction apparatus, for example, switch a state of the game. In response to monitoring an abnormality of the game, the service system will also send a warning through the user interaction apparatus.

In each state of the game, the player or the dealer must operate in compliance with a game rule. In a Baccarat game, it is required to deal the cards to the areas corresponding to the banker and the player at the game table in a specific sequence. Generally, the first four cards are dealt in a fixed sequence, that is, the first and third cards are dealt to the player, and the second and fourth cards are dealt to the banker. Whether the fifth and sixth cards are dealt or dealt to the banker or the player will be determined based on the points of the first four cards.

When the game is in the betting state, if it is determined based on the videos collected by the cameras that the dealer deals the first card, the state of the game is switched from the betting state to the gaming state, a target video frame from which the information of the card can be detected stably is determined from the video frames, the information such as position, suit, point and the like of the dealt first card is identified based on the target video frame, and whether the first card is placed in the specified area, for example, an area corresponding to the banker or an area corresponding to the player, can be determined according to the position information of the card and the card dealing sequence. Next, the dealing sequence identifier of the card and information such as the position, suit, point and the like of the card are stored in an associated manner. In the target video frame, the coverage ratio of the hand of the dealer to the card is smaller than a preset threshold (that is, the hand of the dealer separates from the card, which means the card is placed stably), and the position of the card in a plurality of video frames collected before the target video frame is consistent with the position of the card in the target video frame.

Subsequently, for the video frames collected by the cameras, the target video frame in which the coverage ratio of the hand of dealer to the card is smaller than the preset threshold and in which the position of the card remains unchanged in comparison to the position of the card in a plurality of successive video frames may be firstly determined from the video frames, and then the information such as position, suit, point and the like of the card is identified from the target video frame, and then a new card is determined according to the information of the card identified from the target video frame and the pre-stored correspondence of the information of card and the dealing sequence identifier to continuously update the card dealing sequence identifier, and the information such as position, suit, point and the like of the card in a cache, and determine whether the new card is placed in the specified area (the area corresponding to the banker or the area corresponding to the player) based on the position information of the new card.

If it is detected based on the video that the card is dealt in a wrong sequence or the card is not placed in the specified area, warning information is sent through the user interaction apparatus to prompt the user.

When the game is in the payout state, a payout result of each player may be determined based on the circumstances of the cards on the game table. At this time, the circumstances on the game table can still be detected based on the above detection logic. If it is detected that a number of cards in the areas corresponding to the banker and the player in a video frame increases (i.e. larger than the number of cards on the game table at the time of settlement), it is thought that the dealer draws a new card in violation of a card dealing rule in the payout stage. At this time, warning information may be sent out through the user interaction apparatus and the game state is switched to the halt state.

By the above method, the card dealing operation of the dealer in violation of the game rule in the game process can be automatically detected, ensuring the game proceeds in order.

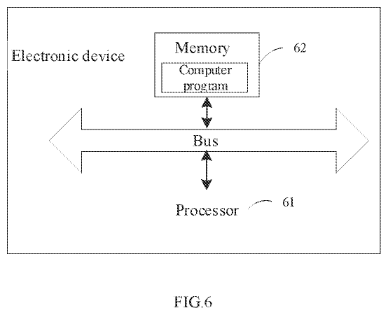

Corresponding to the above method, the examples of the present disclosure further provide an apparatus for detecting a game prop operation event. As shown in FIG. 5, the apparatus 50 includes the following modules:

an obtaining module 51, configured to obtain a first video frame of a game area;

a detecting module 52, configured to obtain a target detection result by detecting information of one or more game props in the first video frame;

an operation sequence identifier determining module 53, configured to determine an operation sequence identifier of each of the one or more game props in the first video frame according to a comparison of the target detection result and a historical detection result, wherein the operation sequence identifier is used to indicate an order of operating the game prop by an operating member, and the historical detection result is determined based on information of one or more game prop in a second video frame collected before the first video frame;

an abnormality determining module 54, configured to determine whether there is an abnormal game prop operation event occurring in the game area according to a matching result of the determined operation sequence identifier of the game prop and position information of the game prop, wherein the position information is used to indicate a position of the game prop in the game area.

In some examples, the information of the game prop includes at least one of the position information of the game prop or identification information displayed on an identification face of the game prop.

In some examples, the detection apparatus is further configured to store the operation sequence identifier of the game prop and the information of the game prop in an associated manner.

In some examples, when obtaining the first video frame of the game area, the obtaining module is specifically configured to:

obtain an original video frame of the game area;

in response to detecting that a coverage ratio of the operating member to the game prop in the original video frame is smaller than a preset threshold and a position of the game prop in the original video frame is consistent with a position of the game prop in N frames previous to the original video frame, determine the original video frame as the first video frame, wherein N is a positive integer.

In some examples, when obtaining the first video frame of the game area, the obtaining module is specifically configured to:

in response to that a state of a game in the game area is a game prop operation state, obtain the first video frame of the game area.

In some examples, the coverage ratio of the operating member to the game prop is determined by:

determining a first detection box corresponding to the game prop in the original video frame;

determining a second detection box corresponding to the operating member in the original video frame;

determining the coverage ratio of the operating member to the game prop according to a coverage ratio of the second detection box to the first detection box.

In some examples, when determining whether there is an abnormal game prop operation event occurring in the game area according to the matching result of the determined operation sequence identifier of the game prop and the position information of the game prop, the abnormality determining module is specifically configured to:

in response to determining that the operation sequence identifier of the game prop and the position information of the game prop are matched, determine that there is no abnormal game prop operation event occurring in the game area.

In some examples, the game area includes a first sub-area and a second sub-area in which the one or more game props are placed; in response to determining that the operation sequence identifier of the game prop and the position information of the game prop are matched, determining that the game prop operation event occurring in the game area is not abnormal includes: determine that there is no abnormal game prop operation event occurring in the game area under condition of detecting that a matching result of the operation sequence identifier and the position information of the game prop satisfies the following:

the operation sequence identifier indicates that the game prop is the first game prop or the third game prop operated by the operating member, and the position information indicates that the game prop is located in the first sub-area; or

the operation sequence identifier indicates that the game prop is the second game prop or the fourth game prop operated by the operating member, and the position information indicates that the game prop is located in the second sub-area; or

the operation sequence identifier indicates that the game prop is the fifth or sixth game prop operated by the operating member, and the position information indicates that the game prop is located in a target sub-area, wherein the target sub-area is determined based on identification information displayed on identification faces of the first to fourth game props operated by the operating member, and the target sub-area is the first sub-area or the second sub-area.

In some examples, in response to determining that there is an abnormal game prop operation event occurring in the game area according to the matching result of the operation sequence identifier of the game prop and the position information of the game prop, the abnormality detecting module is further configured to send abnormality prompt information.

In some examples, the detection apparatus is further configured to:

in response to detecting that a number of game props in the game area is not matched with a number of game props in the game area at the time of determining a game processing result, send abnormality prompt information.

In some examples, the game in the game area includes a card game and the game prop includes a card.

The examples of the present disclosure further provide an electronic device. As shown in FIG. 6, the electronic device includes a processor 61, a memory 62, and a computer program stored in the memory 62 and executable by the processor 61, where the computer program is executed by the processor to implement the method according to any one of the above examples.

The examples of the present disclosure further provide a computer readable storage medium storing computer readable instructions thereon, where the instructions are executed by a processor to implement the method according to any one of the above examples.

The computer readable medium includes permanent, non-permanent, mobile and non-mobile media, which can realize information storage by any method or technology. The information may be computer readable instructions, data structures, program modules and other data. The examples of the computer storage medium include but not limited to: a phase change random access memory (PRAM), a Static Random Access Memory (SRAM), a Dynamic Random Access Memory (DRAM), and other types of RAMs, Read-Only Memory (ROM), an Electrically-Erasable Programmable Read-Only Memory (EEPROM), a Flash Memory, or other memory technology, CD-ROM, digital versatile disc (DVD) or other optical storage, cassette type magnetic tape, magnetic disk storage, or other magnetic storage device or other non-transmission medium for storing information accessible by computing devices. According to the definition of the specification, the computer readable medium does not include transitory computer readable media, for example, modulated data signal and carriers.

It may be known from descriptions of the above examples that persons skilled in the art may clearly understand that the examples of the present disclosure may be implemented by means of software and a necessary general hardware platform. Based on such understanding, the technical solutions of examples of the present disclosure essentially or a part contributing to the prior art may be embodied in the form of a software product, and the computer software product may be stored in a storage medium, such as a ROM/RAM, a diskette or a compact disk, and includes several instructions for enabling a computer device (such as a personal computer, a server or a network device) to perform the methods of different examples or some parts of the examples of the present disclosure.

The systems, apparatuses, modules or units described in the above examples may be specifically implemented by a computer chip or an entity, or may be implemented by a product with a particular function. A typical implementing device may be a computer, and the computer may specifically be a personal computer, a laptop computer, a cellular phone, a camera phone, a smart phone, a personal digital assistant, a media player, a navigation device, an email transceiver, a game console, a tablet computer, a wearable device, or a combination of any several devices of the above devices.

The examples in the present disclosure are described in a progressive manner, each embodiment focuses on differences from other examples, and same or similar parts among the examples may be referred to each other. Especially, since apparatus examples are basically similar to method examples, simple descriptions are made to the apparatus examples, and relevant parts may be referred to part of the descriptions of the method examples. The apparatus examples described above are merely illustrative, where modules described as separate members may be or not be physically separated, and functions of different modules may be implemented in the same or several software and/or hardware during implementation of the examples of the present disclosure. Part or all of the modules may also be selected according to actual requirements to achieve the objectives of the solution of the embodiment. Persons of ordinary skill in the art may understand and implement the solutions without creative work.

1. A method of detecting a game prop operation event, comprising:
obtaining a first video frame of a game area;
obtaining a target detection result by detecting information of one or more game props in the first video frame;
determining an operation sequence identifier of each of the one or more game props in the first video frame according to a comparison of the target detection result and a historical detection result, wherein the operation sequence identifier is used to indicate an order of operating the game prop by an operating member, and the historical detection result is determined based on information of one or more game props in a second video frame collected before the first video frame;
determining whether there is an abnormal game prop operation event occurring in the game area according to a matching result of the determined operation sequence identifier of the game prop and position information of the game prop, wherein the position information is used to indicate a position of the game prop in the game area.

2. The method according to claim 1, wherein the information of the game prop comprises at least one of the position information of the game prop or identification information displayed on an identification face of the game prop.

3. The method according to claim 1, further comprising:
storing the operation sequence identifier of the game prop and the information of the game prop in an associated manner.

4. The method according to claim 1, wherein obtaining the first video frame of the game area comprises:
obtaining an original video frame of the game area;
in response to detecting that a coverage ratio of the operating member to the game prop in the original video frame is smaller than a preset threshold and a position of the game prop in the original video frame is consistent with a position of the game prop in N frames previous to the original video frame, determining the original video frame as the first video frame, wherein N is a positive integer.

5. The method according to claim 1, wherein obtaining the first video frame of the game area comprises:
in response to that a state of a game in the game area is a game prop operation state, obtaining the first video frame of the game area.

6. The method according to claim 4, wherein the coverage ratio of the operating member to the game prop is determined by:
determining a first detection box corresponding to the game prop in the original video frame;
determining a second detection box corresponding to the operating member in the original video frame; and
determining the coverage ratio of the operating member to the game prop according to a coverage ratio of the second detection box to the first detection box.

7. The method according to claim 1, wherein determining whether there is an abnormal game prop operation event occurring in the game area according to the matching result of the determined operation sequence identifier of the game prop and the position information of the game prop comprises:
in response to determining that the operation sequence identifier of the game prop and the position information of the game prop are matched, determining that there is no abnormal game prop operation event occurring in the game area.

8. The method according to claim 7, wherein the game area comprises a first sub-area and a second sub-area in which the one or more game props are placed;
in response to determining that the operation sequence identifier of the game prop and the position information of the game prop are matched, determining that there is no abnormal game prop operation event occurring in the game area comprises:
determining that there is no abnormal game prop operation event occurring in the game area under condition of detecting that a matching result of the operation sequence identifier and the position information of the game prop satisfies the following:
the operation sequence identifier indicates that the game prop is a first game prop or a third game prop operated by the operating member, and the position information indicates that the game prop is located in the first sub-area; or
the operation sequence identifier indicates that the game prop is a second game prop or a fourth game prop operated by the operating member, and the position information indicates that the game prop is located in the second sub-area; or
the operation sequence identifier indicates that the game prop is a fifth or sixth game prop operated by the operating member, and the position information indicates that the game prop is located in a target sub-area, wherein the target sub-area is determined based on identification information displayed on identification faces of the first to fourth game props operated by the operating member, and the target sub-area is the first sub-area or the second sub-area.

9. The method according to claim 1, wherein in response to determining that there is an abnormal game prop operation event occurring in the game area according to the matching result of the operation sequence identifier of the game prop and the position information of the game prop, sending abnormality prompt information.

10. The method according to claim 1, further comprising:
in response to detecting that a number of game props in the game area is not matched with a number of game props in the game area at the time of determining a game processing result, sending abnormality prompt information.

11. The method according to claim 1, wherein a game in the game area comprises a card game and the game prop comprises a card.

12. An electronic device, comprising a processor, a memory, and a computer program stored in the memory and executable by the processor, wherein when executing the computer program, the processor is caused to:
obtain a first video frame of a game area;
obtain a target detection result by detecting information of one or more game props in the first video frame;
determine an operation sequence identifier of each of the one or more game props in the first video frame according to a comparison of the target detection result and a historical detection result, wherein the operation sequence identifier is used to indicate an order of operating the game prop by an operating member, and the historical detection result is determined based on information of one or more game props in a second video frame collected before the first video frame;
determine whether there is an abnormal game prop operation event occurring in the game area according to a matching result of the determined operation sequence identifier of the game prop and position information of the game prop, wherein the position information is used to indicate a position of the game prop in the game area.

13. The electronic device according to claim 12, wherein the information of the game prop comprises at least one of the position information of the game prop or identification information displayed on an identification face of the game prop.

14. The electronic device according to claim 12, the processor is further caused to:
store the operation sequence identifier of the game prop and the information of the game prop in an associated manner.

15. The electronic device according to claim 12, wherein when obtaining the first video frame of the game area, the processor is caused to:
obtain an original video frame of the game area;
in response to detecting that a coverage ratio of the operating member to the game prop in the original video frame is smaller than a preset threshold and a position of the game prop in the original video frame is consistent with a position of the game prop in N frames previous to the original video frame, determine the original video frame as the first video frame, wherein N is a positive integer.

16. The electronic device according to claim 12, wherein when obtaining the first video frame of the game area, the processor is caused to:
in response to that a state of a game in the game area is a game prop operation state, obtain the first video frame of the game area.

17. The electronic device according to claim 15, wherein the coverage ratio of the operating member to the game prop is determined by:
determining a first detection box corresponding to the game prop in the original video frame;
determining a second detection box corresponding to the operating member in the original video frame; and
determining the coverage ratio of the operating member to the game prop according to a coverage ratio of the second detection box to the first detection box.

18. The electronic device according to claim 12, wherein when determining whether there is an abnormal game prop operation event occurring in the game area according to the matching result of the determined operation sequence identifier of the game prop and the position information of the game prop, the processor is caused to:
in response to determining that the operation sequence identifier of the game prop and the position information of the game prop are matched, determine that there is no abnormal game prop operation event occurring in the game area.

19. The electronic device according to claim 18, wherein the game area comprises a first sub-area and a second sub-area in which the one or more game props are placed;
when determining that there is no abnormal game prop operation event occurring in the game area in response to determining that the operation sequence identifier of the game prop and the position information of the game prop are matched, the processor is caused to:
determine that there is no abnormal game prop operation event occurring in the game area under condition of detecting that a matching result of the operation sequence identifier and the position information of the game prop satisfies the following:
the operation sequence identifier indicates that the game prop is a first game prop or a third game prop operated by the operating member, and the position information indicates that the game prop is located in the first sub-area; or
the operation sequence identifier indicates that the game prop is a second game prop or a fourth game prop operated by the operating member, and the position information indicates that the game prop is located in the second sub-area; or
the operation sequence identifier indicates that the game prop is a fifth or sixth game prop operated by the operating member, and the position information indicates that the game prop is located in a target sub-area, wherein the target sub-area is determined based on identification information displayed on identification faces of the first to fourth game props operated by the operating member, and the target sub-area is the first sub-area or the second sub-area.

20. A detection system, comprising an image collection apparatus, a service system and a user interaction apparatus;
wherein the image collection apparatus is configured to collect a video of a game area and send the video to the service system;
the service system is configure to:
obtain a first video frame from the video;
obtain a target detection result by detecting information of one or more game props in the first video frame;
determine an operation sequence identifier of each of the one or more game props in the first video frame according to a comparison of the target detection result and a historical detection result, wherein the operation sequence identifier is used to indicate an order of operating the game prop by an operating member, and the historical detection result is determined based on information of one or more game props in a second video frame collected before the first video frame;
determine whether there is an abnormal game prop operation event occurring in the game area according to a matching result of the determined operation sequence identifier of the game prop and position information of the game prop, wherein the position information is used to indicate a position of the game prop in the game area; and
notify the user interaction apparatus in response to determining that there is an abnormal game prop operation event;
the user interaction apparatus is configured to send abnormality prompt information to prompt a user.
